(19) United States
(12) Patent Application Publication
(10) Pub. No.: US 2002/0108022 A1
(43) Pub. Date: Aug. 8, 2002

(54) SYSTEM AND METHOD FOR ALLOWING BACK TO BACK WRITE OPERATIONS IN A PROCESSING SYSTEM UTILIZING A SINGLE PORT CACHE

(76) Inventor: HONG-YI HUBERT CHEN, FREMONT, CA (US)

Correspondence Address: JOSEPH A SAWYER JR, SAWYER LAW GROUP LLP, P O BOX 51418, PALO ALTO, CA, 94303, US

(21) Appl. No.: 09/300,898

(22) Filed: Apr. 28, 1999

(51) Int. Cl. G06F 12/08

(52) U.S. Cl. 711/140; 711/104; 711/168; 711/169

(57) ABSTRACT

A method and system for allowing back to back write operations utilizing a single port cache is disclosed. The method and system comprises overlapping and pipelining the tag lookup and data write instruction. In so doing, the processor would be able to perform single cycle cache hit detection/data write in a single port SRAM data cache. Two instructions can be operated on simultaneously without either of the two stages being idle. Accordingly, during the tag lookup cycle the data can be read while the data write cycle writes data. This simple pipelining procedure will allow the number of instruction cycles reduced down to only one cycle. Moreover, this methodology will work for consecutive read seek and data write to the same memory address as well.

### FIELD OF THE INVENTION

The present invention relates generally to a data processing system and more particularly to a processing system that includes a single port cache.

### BACKGROUND OF THE INVENTION

A processing system includes a plurality of pipeline stages. The pipeline stages of a processing system typically comprise a fetch (F) stage, a decode (D) stage, an execute (E) stage, a memory (M) stage, and a write back (W) stage. The processing system typically includes a general purpose processor. The general purpose processor includes a core processor and an instruction cache, data cache, and writeback device which are coupled to a bus interface unit. In such a system, in the traditional model, the data cache will be typically a single port device. In this type of system, two cycles are needed for cache hit detection and a write cycle. That is, one cycle is required to perform a read operation, and a second cycle is needed to perform a data write. Accordingly, two cycles are required to provide a write operation.

For a write operation, in the first cycle it is determined whether there is a cache hit or miss, and in the second cycle a data write is performed if there is a cache hit. When there are two consecutive write operations, a cycle is wasted. If the data reads and data writes are from two different memory locations, then the two cycles have to be performed independent of each other. Accordingly, oftentimes to allow two consecutive write operations to be performed more efficiently, a two port data cache device is utilized. However, in so doing, there is additional expense and complexity associated therewith. What is desired, therefore, is to be able to use a single port SRAM cache and not have the overhead problems associated with two consecutive write cycles. A system to overcome this problem must be easy to implement, must be straight forward, and must be a cost-effective alternative. The present invention addresses such a need.

### SUMMARY OF THE INVENTION

A method and system for allowing back to back write operations utilizing a single port cache is disclosed. The method and system comprises overlapping and pipelining the tag lookup and data write instruction. In so doing, the processor would be able to perform single cycle cache hit detection/data write in a single port SRAM data cache. Two instructions can be operated on simultaneously without either of the two stages being idle. Accordingly, during the tag lookup cycle the data can be read while the data write cycle writes data. This simple pipelining procedure will allow the number of instruction cycles reduced down to only one cycle. Moreover, this methodology will work for consecutive read seek and data write to the same memory address as well.

### BRIEF DESCRIPTION OF THE DRAWINGS

FIG. 1 is a simple block diagram of a processor system.

FIG. 2 is a detailed block diagram of a processor system.

FIG. 3 is a model of a traditional back to back write operations using a conventional single port read cache.

FIG. 4 is a diagram that illustrates a pipelining procedure in accordance with the present invention, in which multiple writes can be written simultaneously.

### DETAILED DESCRIPTION

The present invention relates to an improvement in a processing system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

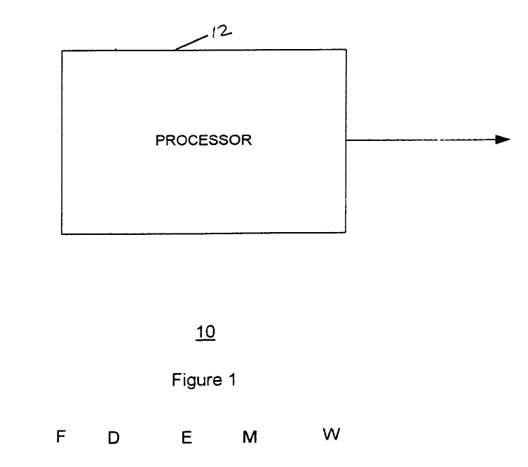

FIG. 1 is a simple block diagram of a processing system 10 in accordance with the present invention. The pipeline stages of the processing system 10 comprise a fetch (F) stage, a decode (D) stage, an execute (E) stage, a memory (M) stage and a write (W) stage.

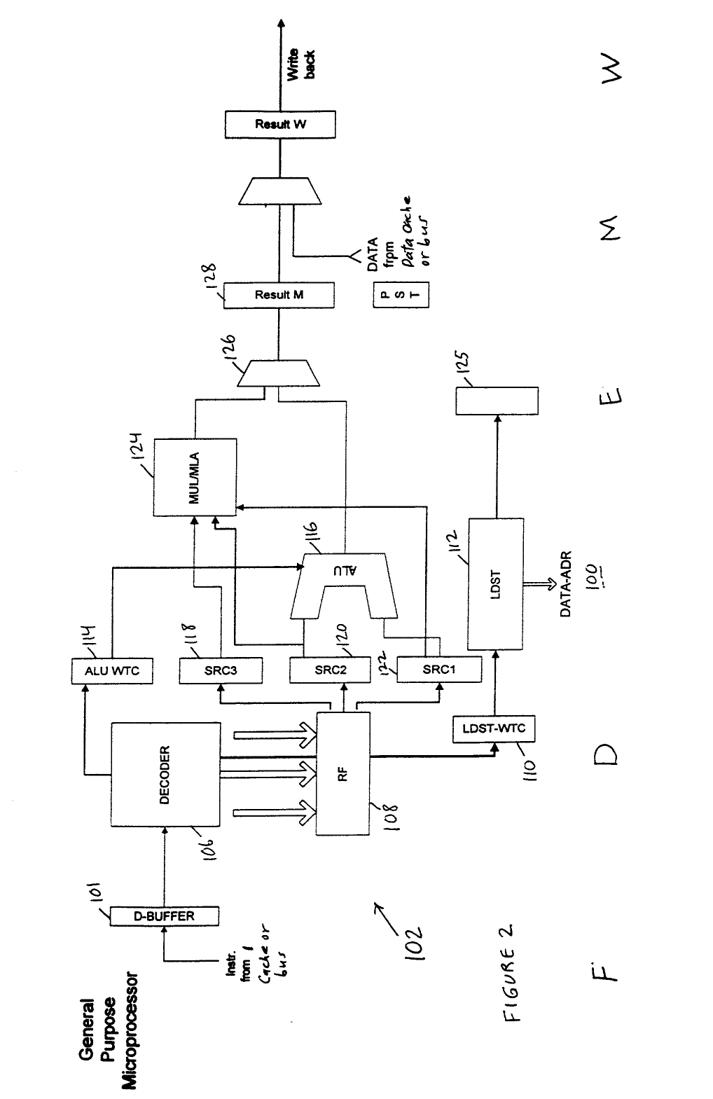

FIG. 2 is a detailed block diagram of a processing system 100. The processing system 100 includes a general purpose processor 102. This system is a processing system which includes the fetch stage, decode stage, execute stage, execution stage, memory stage and writeback stage as described with FIG. 1.

General Purpose Processor 102

The general purpose processor 102 operates in a conventional manner. For example, when data instructions are provided to the decoder 106 via data buffer 101, the decoder 106 provides information to the register file (RF) 108. The RF 108 provides control information to a load store register 110. The load store register 110 retains information for the operation of the load store unit 112. The decoder 106 provides control information to an arithmetic logic unit register 114. An ALU register 114 holds information to control the ALU 116. The RF 108 provides operand information to three registers 118, 120 and 122.

As is seen, the results of register 118, 120 and 122 are provided to a multiply/multiply add unit 124. The results of register 120 and register 122 are provided to the ALU 116. In the load store operation all the addresses to the E stage are provided as is shown to the data register 125, and the data will come back in the M stage. Accordingly, if the data is a multiply instruction, the multiply unit 124 will generate the result 128 during the M stage. If the data is an ALU instruction, then the ALU 116 will generate the result during the execution stage.

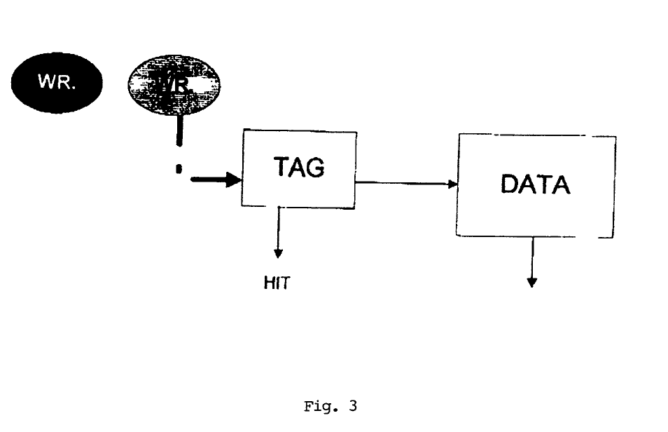

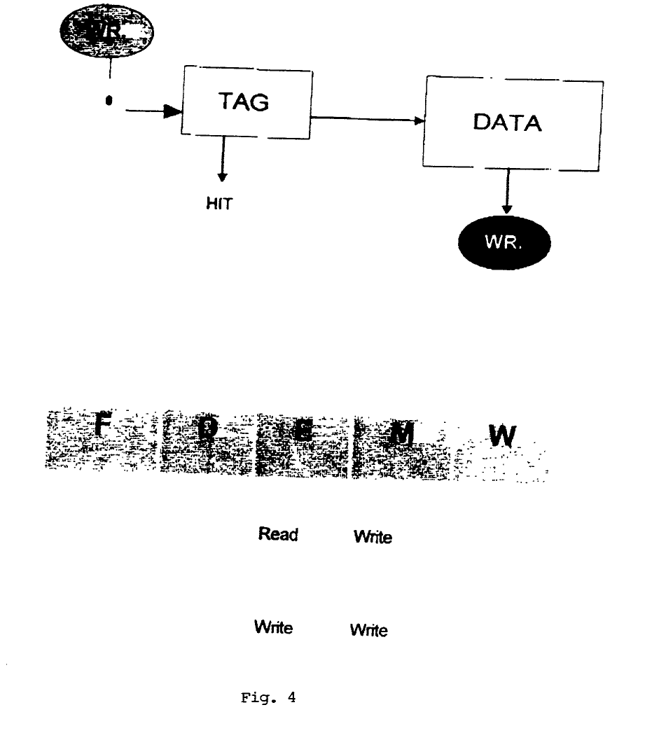

FIG. 3 shows a simplified view of the relevant portion of the processing system of the present invention. In this environment, in the traditional model, the data cache will be typically a single port device. FIG. 3 illustrates a single port SRAM 200 which receives address signals, read/write signals and data signals. In the traditional model, two cycles are needed for cache hit detection or read and a write. Referring now to FIG. 4, what is shown is the traditional model. That is, there is one cycle which is used to set up to perform a read, and another cycle is needed to set up to perform a write. Accordingly, two cycles are required to provide a write.

The first cycle is for the tag SRAM to look up data to determine whether it is a cache hit or miss, and the second cycle is to perform a data write to the data SRAM. In this model, if there are two consecutive write operations, a cycle is wasted. If the data seeks and data writes are from two different memory locations, then two cycles have to be performed independent of each other. Accordingly, what is oftentimes done is to make the cache a two port device. However, in so doing, there is additional expense and complexity associated therewith. It has been estimated that there is 30 to 40% increase in transistors for each additional port. What is desired, therefore, is to be able to use a single port data cache and not have the overhead problems associated with two consecutive write cycles.

A method and system for allowing back to back write operations utilizing a single port data cache device is disclosed. The method and system comprises overlapping and pipelining the tag lookup and data write instruction. In so doing, the processor would be able to perform single cycle cache hit detection/data write in a single port SRAM data cache. Two instructions can be operated on simultaneously without either of the two stages being idle. Accordingly, during the tag lookup cycle the data can be read while the data write cycle writes data. This simple pipelining procedure will allow the number of instruction cycles to be reduced down to only one cycle. Moreover, this methodology will work for consecutive data seek and data write to the same memory address as well.

The present invention takes advantage of the fact that the Tag SRAM and data SRAM can be overlapped for two consecutive write operations. To more explicitly describe the features of the present invention refer now to the following discussion in conjunction with the accompanying figures. FIG. 4 illustrates a system in accordance with the present invention.

In this system, a read address for a particular write operation is presented to a TAG SRAM 402 to provide tag lookup information. The write address is provided to the DATA SRAM 404. Accordingly, if there are back to back write operations, during the second write operation, the read address can be provided to the TAG SRAM 402 at the same time that the write address for that second write operation is provided to the DATA SRAM 404. In so doing, the DATA SRAM 404 can output the data or perform a write during the same cycle as a read provided the tag lookup in the TAG SRAM 402 indicates a cache hit.

Accordingly, during the tag lookup cycle the data can be read while the data cycle writes data. This simple pipelining procedure will allow the number of instruction cycles reduced down to only one cycle. Moreover, this methodology will work for consecutive data seek and data write to the same memory address as well.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

What is claimed is:

1. A method for allowing back to back write operations in a processing system utilizing a single port cache comprising the steps of:
overlapping a tag lookup operation and a write operation; and
outputting data from the cache when the tag lookup operation indicates a hit in the single port cache.

2. The method of claim 1 wherein the single port cache includes:
a data SRAM; and
a tag SRAM.

3. The method of claim 2 wherein the tag SRAM receives read addresses and the data SRAM receives write addresses.

4. The method of claim 3 wherein the tag SRAM provides cache hit detection via the tag lookup operation.

5. The method of claim 4 wherein the write operation is a second write operation of a first and second write operations.

6. A system for allowing back to back write operations in a processing system utilizing a single port cache comprising:
means for overlapping a tag lookup operation and a write operation; and
means for outputting data from the cache when the tag lookup operation indicates a hit in the single port cache.

7. The system of claim 6 wherein the single port cache includes:
a data SRAM; and
a tag SRAM.

8. The system of claim 7 wherein the tag SRAM receives read addresses and the data SRAM receives write addresses.

9. The system of claim 8 wherein the tag SRAM provides cache hit detection via the tag lookup operation.

10. The system of claim 9 wherein the write operation is a second write operation of a first and second write operations.
